(19) United States
(12) Patent Application Publication
(10) Pub. No.: US 2002/0146127 A1
(43) Pub. Date: Oct. 10, 2002

(54) System and method for providing secure communications between wireless units using a common key

(76) Inventor: Marcus Wong, Piscataway, NJ (US)

Correspondence Address: Docket Administrator ( Room 3C-512), Lucent Technologies Inc., 600 Mountain Avenue, P.O. Box 636, Murray Hill, NJ, 07974-0636, US

(21) Appl. No.: 09/827,226

(22) Filed: Apr. 5, 2001

(51) Int. Cl. H04K 1/00

(52) U.S. Cl. 380/270; 380/277

(57) ABSTRACT

A system and method uses a common key provided to a first wireless unit and a second wireless unit to use in secure communications between the first and second wireless units over at least one wireless communications system. By providing a common key to the first and second wireless units, the common key security system alleviates the at least one wireless communications system from having to perform the security methods used to provide secure communications between the first and second wireless units. For example, the encryption/decryption of the communications between the first wireless unit and the second wireless unit can be performed at the first and second wireless units using the common key. In certain embodiments, the first and second wireless units and the serving wireless communications system(s) still perform authentication and obtain keys CK₁ and CK₂ as described above. However, instead of using the keys CK₁ and CK₂ to encrypt/decrypt communications between the first and second wireless units at the serving wireless communications system(s), a common key at the first wireless unit is used to encrypt/decrypt information which is decrypted/encrypted at the second wireless unit using the common key. The common key can be generated by the wireless communications system(s) and provided to the first and second wireless units by the serving wireless communications system(s) which can use the respective keys CK₁ and CK₂ to securely provide the common key to the first and second wireless units. Once the receipt of the common key by the first and second wireless units is verified, the first and second wireless units can securely communicate with each other using the common key, and the serving wireless communications system(s) can simply act as a conduit for the communications between the first and second wireless units.

### BACKGROUND OF THE INVENTION

1. Field of the Invention

The present invention relates to communications; more specifically, the generation, distribution and/or use of a common key to provide secure communications between wireless units.

2. Description of Related Art

FIG. 1 depicts a schematic diagram of first and second wireless communications systems which provide wireless communications service to wireless units (e.g., wireless units 12a-c) that are situated within the geographic regions 14 and 16, respectively. A Mobile Switching Center (e.g. MSCs 20 and 24) is responsible for, among other things, establishing and maintaining calls between the wireless units, calls between a wireless unit and a wireline unit (e.g., wireline unit 25), and/or connections between a wireless unit and a packet data network (PDN), such as the internet. As such, the MSC interconnects the wireless units within its geographic region with a public switched telephone network (PSTN) 28 and/or a packet data network (PDN) 29. The geographic area serviced by the MSC is divided into spatially distinct areas called “cells.” As depicted in FIG. 1, each cell is schematically represented by one hexagon in a honeycomb pattern; in practice, however, each cell has an irregular shape that depends on the topography of the terrain surrounding the cell.

Typically, each cell contains a base station (e.g. base stations 22a-e and 26a-e), which comprises the radios and antennas that the base station uses to communicate with the wireless units in that cell. The base stations also comprise the transmission equipment that the base station uses to communicate with the MSC in the geographic area. For example, MSC 20 is connected to the base stations 22a-e in the geographic area 14, and an MSC 24 is connected to the base stations 26a-e in the geographic region 16. The MSCs 20 and 24 use a signaling network 32, such as a signaling network conforming to the standard identified as TIA/EIA-41-D entitled “Cellular Radiotelecommunications Intersystem Operations,” December 1997 (“IS-41”), which enables the exchange of information between the wireless communications systems.

In the example of FIG. 1, the wireless unit 12a is located within the geographic area 14 of the MSC 20 to which the wireless unit 12a was originally assigned (e.g. the home MSC). Before being allowed access to the wireless communications system, the wireless unit 12a is authenticated. The wireless unit 12a sends an access request to the base station 22a. In response to the access request, a home authentication center 34 accesses a home location register (HLR) 38 which has a registration entry for wireless unit 12a. The home location register entry may be associated with the wireless unit 12a by an identifier such as the wireless unit's telephone number. The information contained in the HLR 38 can include and/or is used to generate authentication keys for authenticating the wireless unit and/or encryption keys to further secure communications between the wireless unit and the communications system as would be understood by one of skill in the art.

When a wireless unit 12c leaves the geographic area 14 of the MSC 20 to which it was originally assigned (e.g. home MSC), the authentication of the wireless unit 12c involves communicating with the home authentication center 34 of the wireless unit's home communications system. When the wireless unit 12c attempts to access the visiting communications system, base station 26d communicates with a visiting authentication center 36 of the visiting communication system. The visiting authentication center 36 determines from a wireless unit or terminal identifier, such as the telephone number of wireless unit 12c, that the wireless unit 12c is registered with a system that uses the home authentication center 34. Visiting authentication center 36 then communicates with the home authentication center 34 over a network, such as the signaling network 32. The home authentication center 34 then accesses the home location register (HLR) 38 entry for the wireless unit 12c to access information which includes and/or is used to generate the authentication and/or encryption keys.

In a 2G GSM system, the wireless unit and the home location register each have the same root key Kᵢ which is used to generate a session key K_{c}. After the wireless unit is successfully authenticated, the 64 bits long K_{c} session or ciphering key is used for user information confidentiality by encrypting/decrypting information being sent between the wireless unit and the wireless communications system. When the wireless unit roams into another system while in the call, the session key K_{c} is forwarded to the new serving system.

In the UMTS security scheme, the wireless unit and the home location register each produce a session security or ciphering key CK using the root key Kᵢ. The wireless unit also calculates the 128 bit ciphering key CK using the root key Kᵢ. After the wireless unit is successfully authenticated, the ciphering key CK is activated to encrypt/decrypt information being sent between the wireless unit and the wireless communications system. If the wireless unit roams into another serving system while on the call, the ciphering key CK is sent to the new target serving system.

In the 2G IS-41 system used in U.S. TDMA and CDMA systems, the wireless unit and the home location register (HLR) have a root key, known as the A_key. There is a secondary key, known as Shared Secret Data SSD, which is sent to the VLR of the serving system during roaming. SSD is generated from the A_key using a cryptographic algorithm known to those skilled in the art. Using the current value of SSD and a random number, session security keys are calculated by the wireless unit and the serving system. Specifically, the 520 bits Voice Privacy Mask (VPM) is computed, which is used for concealing the TDMA speech data throughout the call. This VPM is derived at the beginning of the call by the wireless unit and the wireless communications system, and, if the mobile roams into another serving system during the call, the VPM is sent to the new serving system by the old VLR. Likewise, the 64 bits Signaling Message Encryption Key (SMEKEY) is computed, which is used for encrypting the TDMA signaling information throughout the call. This SMEKEY is derived at the beginning of the call by the wireless unit and the serving system, and, if the mobile roams into another serving system during the call, the SMEKEY is sent to the new serving system by the VLR.

The 2G CDMA scheme uses a similar method of key distribution, except, instead of the 520 bits VPM, it is using the 42 Least Significant Bits (LSB) of the VPM as a seed into the Private Long Code Mask (PLCM). This PLCM is used as an additional scrambling mask for the information before its spreading. The 42-bit PLCM is consistent throughout the call and is sent to the new serving system by the VLR of the serving system if the mobile roams into another serving system. The SMEKEY is used in the same way as in the TDMA based scheme.

The IS-41 3G security scheme uses the UMTS security scheme, which is based on the delivery of the 128-bits ciphering key CK computed by both the wireless unit and the wireless communications system.

FIG. 2a shows an illustrative example of how secure communications are provided by current wireless communications systems where a first wireless unit 50 is communicating with a second wireless unit 52 in the same wireless communications system 54, for example using the same MSC 56. The first wireless unit 50 and the wireless communications system 54 each have a session key CK₁ which is a function of the root key A_{K1} stored at the wireless unit and at the home location register entry for the wireless unit. Communications between the first wireless unit 50 and the wireless communications system 54 are encrypted/decrypted using the session key CK₁. In similar fashion, the second wireless unit 52 and the wireless communications system 54 each have a session key CK₂ which is a function of the root key A_{K2} stored at the wireless unit and at the home location register entry for the wireless unit. Communications between the second wireless unit 52 and the wireless communications system 54 are encrypted/decrypted using the session key CK₂.

As such, communications between the first wireless unit 50 and the second wireless unit 52 require a significant amount of processing by the wireless communications system 54. The wireless communications system 54 uses the session key CK₁ to encrypt information received from the second wireless unit 52 for transmission to the first wireless unit 50 and to decrypt information received from the first wireless unit 50 for transmission to the second wireless unit 52. The wireless communications system 54 uses the session key CK₂ to encrypt information received from the first wireless unit 50 for transmission to the second wireless unit 52 and to decrypt information received from the second wireless unit 52 for transmission to the first wireless unit 50. Thus, using the current schemes requires a significant amount of processing by the wireless communications system for the encryption/decryption of information being sent between the first and second wireless units 50 and 52.

FIG. 2b shows an illustrative example of how secure communications are provided by current wireless communications systems for communications between a first wireless unit 60 using a first wireless communications system 62 and a second wireless unit 64 using a second wireless communications system 66. The first wireless unit 60 and the first wireless communications system 62 each have a session key CK₁ which is a function of the root key A_{K1} stored at the wireless unit and at the home location register entry for the wireless unit. Communications between the first wireless unit 60 and the first wireless communications system 62 are encrypted/decrypted using the session key CK₁. In similar fashion, the second wireless unit 64 and the second wireless communications system 66 each have a session key CK₂ which is a function of the root key A_{K2} stored at the wireless unit and at the home location register entry for the wireless unit. Communications between the second wireless unit 62 and the second wireless communications system 66 are encrypted/decrypted using the session key CK₂.

The first and second wireless communications systems must perform a significant amount of processing to encrypt/decrypt information for the communications between the first wireless unit 60 and the second wireless unit 64. For instance, the first wireless communications system 62 uses the session key CK₁ to encrypt information received from the second wireless communications system 66 for transmission to the first wireless unit 60 and to decrypt information received from the first wireless unit 60 for the second wireless unit 64. The second wireless communications system 66 uses the session key CK₂ to encrypt information received from the first wireless communications system 62 for transmission to the second wireless unit 64 and to decrypt information received from the second wireless unit 64 for the first wireless unit 60. Thus, as in the above example, the current schemes requires a significant amount of processing by the wireless communications systems for the encryption/decryption of information being sent between the first and second wireless units 60 and 64.

### SUMMARY OF THE INVENTION

The present invention is a system and method using a common key provided to a first wireless unit and a second wireless unit to use in secure communications between the first and second wireless units over at least one wireless communications system. By providing a common key to the first and second wireless units, the common key security system alleviates the at least one wireless communications system from having to perform the security methods used to provide secure communications between the first and second wireless units. For example, the encryption/decryption of the communications between the first wireless unit and the second wireless unit can be performed at the first and second wireless units using the common key. In certain embodiments, the first and second wireless units and the serving wireless communications system(s) still perform authentication and obtain keys CK₁ and CK₂ as described above. However, instead of using the keys CK₁ and CK₂ to encrypt/decrypt communications between the first and second wireless units at the serving wireless communications system(s), a common key at the first wireless unit is used to encrypt/decrypt information which is decrypted/encrypted at the second wireless unit using the common key. The common key can be generated by the wireless communications system(s) and provided to the first and second wireless units by the serving wireless communications system(s) which can use the respective keys CK₁ and CK₂ to securely provide the common key to the first and second wireless units. Once the receipt of the common key by the first and second wireless units is verified, the first and second wireless units can securely communicate with each other using the common key, and the serving wireless communications system(s) can simply act as a conduit for the communications between the first and second wireless units.

### BRIEF DESCRIPTION OF THE DRAWINGS

Other aspects and advantages of the present invention may become apparent upon reading the following detailed description and upon reference to the drawings in which:

FIG. 1 shows a general diagram of wireless communications systems in which the common key security system according to the principles of the present invention can be used;

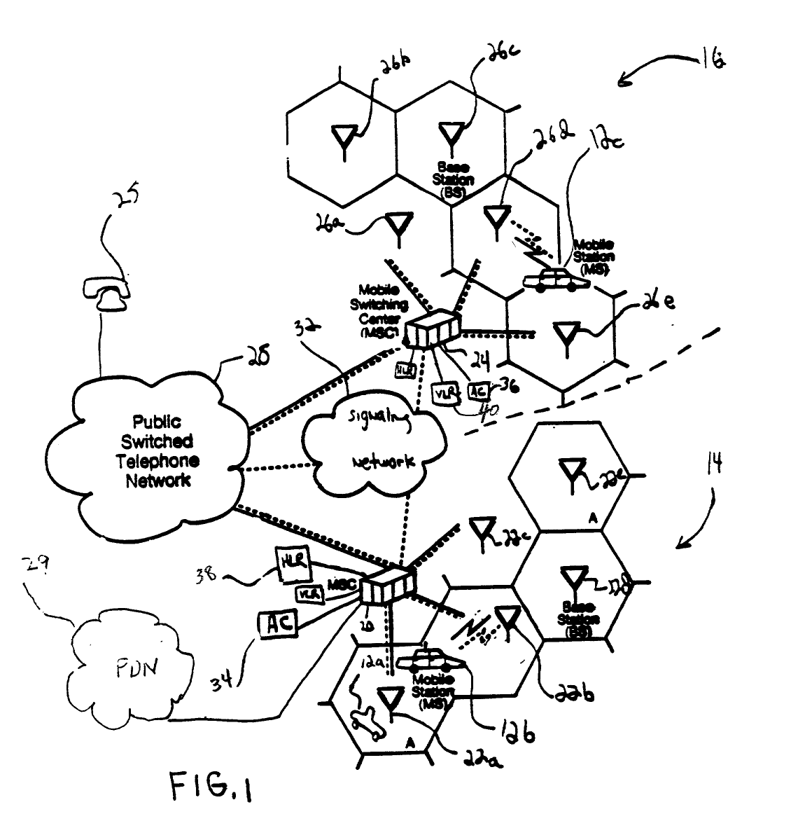

FIG. 2a is a diagram showing an example of how current wireless units securely communicate over the same wireless communications system using session keys;

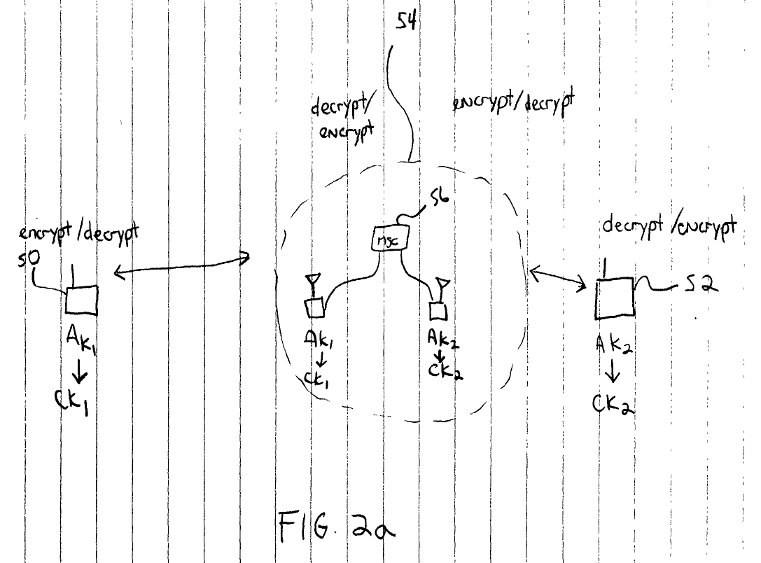

FIG. 2b is a diagram showing an example of how current wireless units securely communicate over different wireless communications systems using session keys;

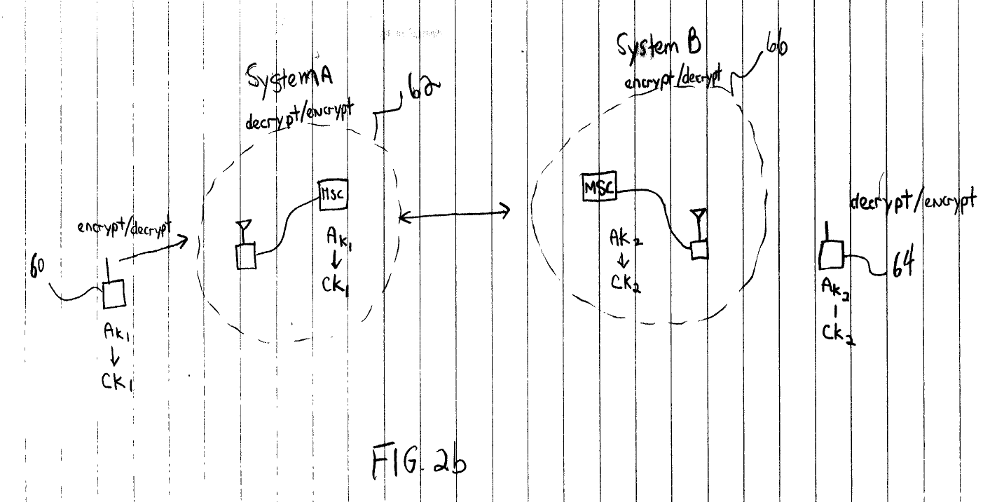

FIG. 3a is a diagram showing an example of how wireless units securely communicate over the same wireless communications system using the common key security system according to principles of the present invention; and

FIG. 3b is a diagram showing an example of how wireless units securely communicate over different wireless communications systems using the common key security system according to principles of the present invention.

### DETAILED DESCRIPTION

An illustrative embodiment of the common key security system according to the principles of the present invention is described below which provides a common key to a first and second wireless for providing secure communications between the first and second wireless units. Depending on the embodiment, the common key can be an encryption key used for encrypting/decrypting of information transmitted/received by the wireless units or an integrity key used for generating a message authentication code to prevent a message from being modified before the message is received by the intended recipient. The common key can be used to conceal/reveal information transmitted and received by the wireless units or to generate a common mask. For example, a common SSD key could be generated to produce a common VPM in the 2G systems described above. In the embodiment described below, the common key is a session key which is established for the duration of the call or connection. A common key according to principles of the present invention could be used after a call, for example during a different call or session between the same parties.

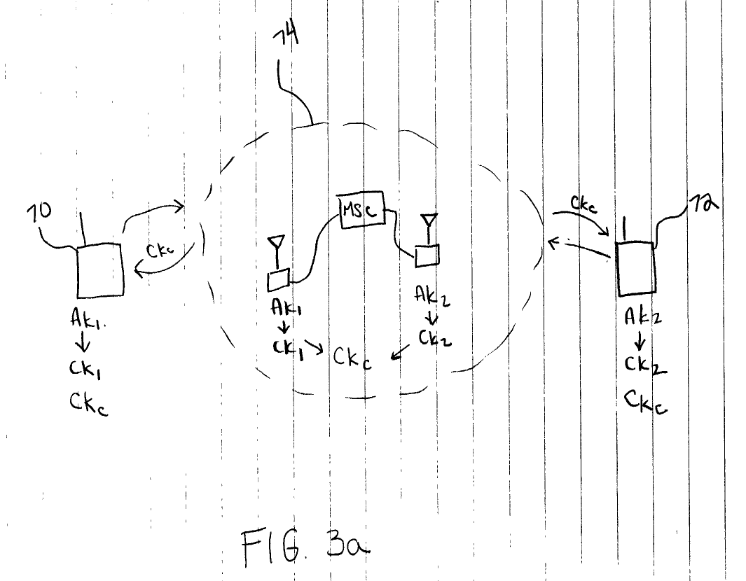

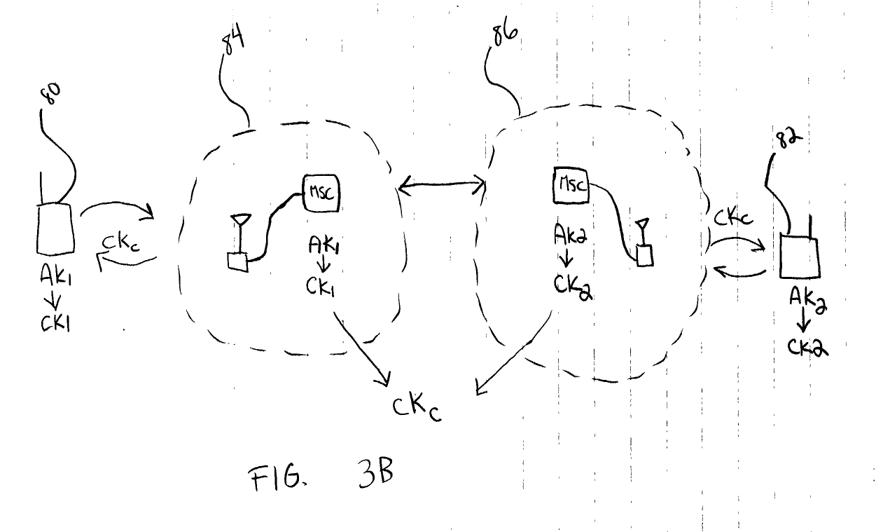

FIG. 3a shows how a first wireless unit 70 and a second wireless unit 72 can securely communicate over the same wireless communications system 74. According to principles of the present invention, the first and second wireless units 70 and 72 use a common key CK_{c} to enable encryption/decryption at the first and second wireless units while the wireless communications system 74 acts as a conduit for the secure communications. As such, at one end, the first wireless unit 70 uses the common key CK_{c} to encrypt information which is transmitted to the wireless communications system 74 for the second wireless unit 72. The first wireless unit 70 also uses the common key CK_{c} to decrypt information received from the wireless communication system 74 from the second wireless unit 72. At the other end, the second wireless unit 72 uses the common key CK_{c} to encrypt information which is transmitted to the wireless communications system 74 for the first wireless unit 70. Moreover, the second wireless unit 72 uses the common key CK_{c} to decrypt information received from the wireless communication system 74 from the second wireless unit 72.

In certain embodiments, the first wireless unit 70 and the wireless communications system 74 each have a session key CK₁ which is derived as a function of the root key A_{K1} at the first wireless 70 unit and at the home location register for the first wireless unit 70. The second wireless unit 72 and the wireless communications system 74 each have a session key CK₂ which is derived as a function of the root key A_{K2} at the second wireless unit 72 and at the home location register for the second wireless unit 70. The wireless communications system can then generate a common session key CK_{c}. The common session key CK_{c} can be generated in different ways as will be discussed below. After the wireless communications system 74 generates the common session key CK_{c}, the wireless communications system 74 sends the common key CK_{c} encrypted using the session CK₁ to the first wireless unit 70. The wireless communications system 74 also sends the common key CK_{c} encrypted using the session key CK₂ to the second wireless unit 72. The first and second wireless units 70 and 72 now can communicate securely using CK_{c} as the common encryption/decryption key. Additionally, the wireless communications system 74 no longer needs to decrypt and re-encrypt the communications between the first and second wireless units 70 and 72.

In generating the common key, a number of key generation techniques could be used. For example, the common key CK_{c} could be generated at the wireless communications system 74 as follows:

Let A=(g^{CK1})mod p

CK_{c}=A^{CK2} mod p

or

Let B=(g^{CK2}) mod p

CK_{c}=B^{CK1} mod p,

where p is a large prime number (e.g. 1024 bits) and g is a generator of p. Note, p can be a strong prime number in that p/2−1 is also prime, and g is a generator of p if g<p and there exists a number x where g^{x} mod p is between 1 and p−1 and there is at least one value of x for every number between 1 and p−1. For example, if p=11, one generator of p=2. Both p and g can be known publicly.

For b=1: (2¹⁰ mod 11)=(1024 mod 11)=1=b

For b=2: (2^{1 mod} 1)=(2 mod 11)=2=b

For b=3: 2⁸ mod 11)=(256 mod 11)=3=b

For b=4: (2²mod 11)=(4 mod 11)=4=b

For b=5: (2⁴mod 11)=(16 mod 11)=5=b

For b=6: (2⁹ mod 11)=(512 mod 11)=6=b

For b=7: (2⁷mod 11)=(128 mod 1)=7=b

For b=8: (2³ mod 11)=(8 mod 11)=8=b

For b=9: (2⁶ mod 11)=(64 mod 11)=9=b

For b=10: (2⁵ mod 11)=(32 mod 11)=10=b

Other generators of p are g=6, 7 or 8.

Other key generation techniques are possible which use the session keys CK1 and CK2 or portions thereof as inputs. However, other key generation techniques are possible which use other inputs or additional inputs, such as A_{key1} and A_{key2} or the SSDs for the wireless units (IS-41). One key generation technique could involve using a hashing function. A hash function such as the functions known as known as SHA-1, MD5, RIPE-MD, can be typically characterized as a function which maps an input of one length to an output of another, and given an output, it is not feasible to determine the input that will map to the given output.

Once the common key CKc is generated and distributed to the wireless units, the common key can be used in an encryption process performed at the wireless units, such as a standard encryption algorithm known as Data Encryption Standard (DES) or Advanced Encryption Standard (AES). Depending on the embodiment, the at least one common key CKc can be used to encrypt/decrypt or conceal/reveal communications between the wireless units while the wireless communications system may simply acts as a conduit for the encrypted or concealed communications. Encryption/decryption used herein encompasses concealing/revealing and/or ciphering/deciphering the communications between the wireless units. By having the wireless units perform encryption/decryption using at least one common key for encryption and decryption, the wireless communications system is alleviated from performing encryption/decryption of the communications between the wireless units.

Depending on the embodiment, the common key CKc can be used in different encryption/decryption or security processes at the wireless units, such as a symmetric encryption standard where the same common key can be used to encrypt and decrypt the communications between the wireless units. In one example, the process receives the common key and a cryptosync, such as a frame number, packet number, time stamp, random number or portions and/or combinations thereof which are known to both wireless units, to produce a mask which is exclusive-ored with the data to encrypt the outgoing information and decrypt the incoming information. In 2G CDMA and TDMA systems, the common key CKc could be used to provide secure communications in place of at least portions of the SSDs or any mask or key derived therefrom. In 3G systems, the common key CKc can be used to provide secure communications in place the session keys CK1 and CK2 or any mask or key derived therefrom.

FIG. 3b shows how wireless units 80 and 82 can securely communicate over different wireless communications systems using the common key security system. According to the principles of the present invention, the first and second wireless units 80 and 82 use a common key CK_{c} to enable encryption/decryption at the first and second wireless units 80 and 82 while the wireless communications systems 84 and 86 acts as a conduit for the secure communications. As such, at one end, the first wireless unit 80 uses the common key CK_{c} to encrypt information which is transmitted through the wireless communications systems 84 and 86 for the second wireless unit 82. The first wireless unit 80 uses the common key CK_{c} to decrypt information from the second wireless unit 82 received from the first wireless communications system 84 through the second wireless communications system 86. At the other end, the second wireless unit 82 uses the common key CK_{c} to encrypt information which is transmitted to the second wireless communications system 86 and through the first wireless communications system 84 to the first wireless unit 80. Moreover, the second wireless unit 82 uses the common key CK_{c} to decrypt information from the first wireless unit 80 received from the second wireless communications system 86 through the first wireless communications system 84.

In certain embodiments, the originating wireless unit and the terminating wireless unit generate session keys CK1 and CK2 respectively as a result of the authentication process. The same CK1 and CK2 are generated respectively in the serving wireless communications systems. Accordingly, the first wireless unit 80 and the first wireless communications system 84 each have a session key CK₁ which is derived as a function of the root key A_{K1}. The session key CK1 is derived at the first wireless unit 80 and at the home location register for the first wireless unit 80 as a result of the authentication process. The second wireless unit 82 and the second wireless communications system 86 each have a session key CK₂ which is derived as a function of the root key A_{K2} at the second wireless unit 82 and at the home location register for the second wireless unit 82. The first and second wireless communications systems 84 and 86 can then generate a common key CK_{c}.

As mentioned above, depending on the embodiment, the common key CK_{c} can be generated in different ways. Key generation techniques are possible which use the session keys CK1 and CK2 or portions thereof as inputs. However, other key generation techniques are possible which use other inputs or additional inputs, such as A_{key1} and A_{key2} or the SSDs for the wireless units (IS-41). One key generation technique could involve using a hashing function. A hash function such as the functions known as known as SHA-1, MD5, RIPE-MD, can be typically characterized as a function which maps an input of one length to an output of another, and given an output, it is not feasible to determine the input that will map to the given output.

The first and second wireless communications systems 84 and 86 can mutually agree on a common session key CKc. This mutual key agreement and exchange can be performed using any of a number of public key or private key schemes and/or key exchange protocols. For example, the first and second wireless communications systems 84 and 86 can perform a Diffie-Hellman key exchange using CK1 and CK2 and generate CKc in the following manner. The first wireless communications system 84 lets A=(g^{CK1}) mod p and sends A to the second wireless communications system 86 which takes A and generates the common key CKc as CK_{c}=A^{CK2} mod p. The second wireless communications system 86 lets B=(g^{CK2}) mod p and sends B to the First wireless communications system takes B and generates the same common key CKc as CK_{c}=B^{CK1} mod p. In the above, p is a large prime number (e.g. 1024 bits) and g is a generator of p. Both p and g can be known publicly. As described for the previous example, p can be a strong prime number in that p/2−1 is also prime, and g is a generator of p if g<p and there exists a number x where g^{x} mod p is between 1 and p−1 and there is at least one value of x for every number between 1 and p−1.

In an example using public keys, the first and second wireless communications systems 84 and 86 each have a pair of public-private keys (PK1_{public} and PK1ₚᵣᵢᵥₐₜₑ) and (PK2_{public} and PK2ₚᵣᵢᵥₐₜₑ), respectively. The public key pairs are well established in advance and PK1_{public} and PK2_{public} are publicly known. PK1ₚᵣᵢᵥₐₜₑ and PK2ₚᵣᵢᵥₐₜₑ are known only to the first and second wireless communications systems 84 and 86, respectively. One of the following 2 ways can be used to agree on a common session key K3:

1) The first wireless communications system 84 generates a common key CKc and uses the public key PK2_{public} of the second wireless communications system 86 to encrypt CKc. The first wireless communications system 84 sends the encrypted CKc to the second wireless communications system 86. The second wireless communications system 86 receives the encrypted CKc and uses PK2ₚᵣᵢᵥₐₜₑ to decrypt it, recovering CKc.

2) The second wireless communications system 86 generates CKc and uses the public key PK1_{public} of the first wireless communications system 84 to encrypt CKc. The second wireless communications system 86 sends the encrypted CKc to the first wireless communications system 84. The first wireless communications system 84 receives the encrypted CKc and uses PK1ₚᵣᵢᵥₐₜₑ to decrypt it, recovering CKc.

In an example using a trusted key distribution center (KDC) and digital signature, the first and second wireless communications systems 84 and 86 each have a pair of public-private keys (PK1_{public} and PK1ₚᵣᵢᵥₐₜₑ) and (PK2_{public} and PK2ₚᵣᵢᵥₐₜₑ), respectively. In addition, the KDC (not shown, which is communicatively coupled in some fashion to the first and/or second wireless communications systems 84 and/or 86) also has a public-private key pair K_{KDC}_{_{—}}_{public} and K_{KDC}_{_{—}}ₚᵣᵢᵥₐₜₑ. The public-private key pairs are well established in advance and PK1_{public}, PK2_{public}, and K_{KDC}_{_{—}}_{public} are publicly known. PK1ₚᵣᵢᵥₐₜₑ, PK2ₚᵣᵢᵥₐₜₑ, and K_{KDC}_{_{—}}ₚᵣᵢᵥₐₜₑ are known only to the first wireless communications system 84, the second wireless communications system 86, and the KDC, respectively.

The KDC generates a common key CKc, signs CKc with its private key K_{KDC}_{_{—}}ₚᵣᵢᵥₐₜₑ, encrypts the signed CKc with the public key PK1_{public} of the first wireless system 84 and sends it to the first wireless system 84. The first wireless system 84 decrypts the message with PK1ₚᵣᵢᵥₐₜₑ and verifies CKc using the KDC's public key K_{KDC}_{_{—}}_{public}. The KDC also encrypts the signed CKc with the public key PK2_{public} of the second wireless communications system 86 and sends it to the second wireless system 86. The second wireless system 86 decrypts the message with PK2ₚᵣᵢᵥₐₜₑ and verifies CKc using the KDC's public key K_{KDC}_{_{—}}_{public}.

At this point from using either one of the three examples above, CKc is ready to be distributed to the first and second wireless units 80 and 82. The first wireless communications system 84 sends the common key CK_{c} encrypted using the session key CK₁ to the first wireless unit 80. The second wireless communications system 84 sends the common key CK_{c} encrypted using the session key CK₂ to the second wireless unit 82. The first and second wireless units 80 and 82 now can communicate securely using CK_{c} as the common encryption/decryption key. Additionally, the first and second wireless communications systems 84 and 86 no longer need to decrypt and re-encrypt the communications between the first and second wireless units 80 and 82.

As described above, once the common key CKc is generated and distributed to the wireless units, the common key can be used in an encryption process performed at the wireless units, such as a standard encryption method known as Data Encryption Standard (DES) or Advanced Encryption Standard (AES). Depending on the embodiment, the at least one common key CKc can be used to encrypt/decrypt or conceal/reveal communications between the wireless units while the first and second wireless communications systems 84 and 86 may simply acts as a conduit for the encrypted, ciphered or concealed communications. As mentioned above, encryption/decryption used herein encompasses concealing/revealing or ciphering/deciphering the communications between the wireless units. By having the wireless units perform encryption/decryption using at least one common key for encryption and decryption, the first and second wireless communications systems 84 and 86 are alleviated from performing encryption/decryption of the communications between the wireless units 80 and 82. Depending on the embodiment, the common key CKc can be used in different encryption/decryption or security processes at the wireless units 80 and 82, such as a symmetric encryption standard where the same common key can be used to encrypt and decrypt the communications between the wireless units 80 and 82. In other embodiments a plurality of common keys are used.

Thus, the described common key security system provides a common key for secure communications between wireless units without the need for the serving wireless communications system(s) to provide decryption and re-encryption of communications between the wireless units. Thus, the wireless communications system(s) can simply act as a conduit for the secure communications between the wireless units with the wireless units performing the encryption/decryption (ciphering/deciphering or concealing revealing) using at least one common key or portion(s) thereof. The common key can be used to provide secure communications in a variety of ways, for example by encrypting/decrypting, concealing/revealing and/or message authentication. In the embodiments described above, the common key is a session encryption key, but depending on the embodiment, the common key can be an encryption, session and/or other type of key or key value. In other embodiments, where the common key is used as an integrity key, the wireless communications system(s) will be alleviated from performing message authentication which can be accomplished at the first and second wireless units.

In accordance with an aspect of embodiments of the common key security system, secure distribution of the common key to a wireless unit is provided by encrypting the common key using a key generated as a result of the authentication process for the wireless unit. In the embodiment described above, the key used to generate and encrypt the common key value is a session key which is generated for the duration of each call or connection. The common key is also a session key. Other types of key values can be used. Additionally, embodiments of the common key security system provide secure generation and distribution of the common key between wireless communications systems.

In addition to the embodiments described above, embodiments of the common key security system according to the principles of the present invention can be used which omit and/or add input parameters and/or use different key generation functions and/or encryption/decryption processes and/or use variations or portions of the described system. For example, specific examples of a common key generation process have been described, but other key generation techniques are possible. Additionally, specific embodiments have been described for distributing the common key to the wireless units and to different wireless communications systems, but other embodiments are possible. Furthermore, the common key is described as being used with particular encryption methods, such as a symmetric encryption method, but other encryption, ciphering, concealing, or generating of security codes, such as a message authentication code, and/or decrypting, deciphering, revealing or message authentication processes are possible which use a single or a plurality of common keys or portions thereof. As such, the common key security system alleviates the intermediary wireless communications system from performing the security methods using keys or key values for communications over links between each wireless unit and the wireless communications system. Instead, the wireless units on a call use the common key to perform the security methods at the wireless units. As such, in the embodiments described above, the wireless units on the call can perform end-to-end encryption and decryption while the wireless communications system(s) simply act as a conduit for the communications. During handoffs, the wireless units can retain the common keys, and the base stations and/or MSCs do not need to pass the keys.

It should be understood that different notations, references and characterizations of the various values, inputs and architecture blocks can be used. In the described embodiments, particular keys are described in the manner which the keys are generated, distributed and used. Depending on the embodiment, the key values and common key value generated, distributed and used by the common key security system can include the described keys, portions thereof, additional or other types of keys, or other values. Moreover, the common key security system and portions thereof can be performed in a wireless unit, base station, base station controller, home authentication center, home location register (HLR), a home MSC, a visiting authentication center, a visitor location register (VLR), a visiting MSC and/or other sub-system in the serving, visiting and/or home wireless communications system(s).

Additionally, the common key security system has been described in FIGS. 3a and 3b with a first and second serving wireless communications system. A serving wireless communications system can be a home wireless communications system with the home MSC assigned to the wireless unit or a visiting wireless communications system with a visiting MSC which has received the session keys from the home wireless communications system after the wireless unit is authenticated. The HLR, VLR and/or the authentication center (AC) can be co-located at the MSC or remotely accessed. It should be understood that the system and portions thereof and of the described architecture can be implemented in or integrated with processing circuitry in the unit or at different locations of the communications system, or in application specific integrated circuits, software-driven processing circuitry, programmable logic devices, firmware, hardware or other arrangements of discrete components as would be understood by one of ordinary skill in the art with the benefit of this disclosure. What has been described is merely illustrative of the application of the principles of the present invention. Those skilled in the art will readily recognize that these and various other modifications, arrangements and methods can be made to the present invention without strictly following the exemplary applications illustrated and described herein and without departing from the spirit and scope of the present invention.

1. A method of providing secure communications between a first wireless unit and a second wireless unit, said method comprising the step of:
providing a common key value to a first wireless unit and for use in secure communications over at least one wireless communications system between said first wireless unit and said second wireless unit having said common key.

2. The method of claim 1 wherein said step of providing comprising the steps of:
generating a first key value corresponding to said first wireless unit;
generating a common key value; and
sending said common key value to said first wireless unit using said first key value.

3. The method of claim 2 comprising the steps of:
generating a second key value corresponding to said second wireless unit; and
sending said common key value to said second wireless unit using said second key value.

4. The method of claim 2 wherein said step of generating comprises the step of:
generating said first key value as a function of a first root key known only at said first wireless unit and a home wireless communications system for said first wireless unit.

5. The method of claim 3 wherein said step of generating comprises the step of:
generating said second key value as a function of a second root key known only at said second wireless unit and at a home wireless communications system for said second wireless unit.

6. The method of claim 2 wherein said step of providing comprises the steps of:
encrypting said common key using said first key value; and
transmitting said common key encrypted with said first key value to said first wireless unit.

7. The method of claim 3 wherein said step of providing comprises the steps of:
encrypting said common key with said second key value; and
transmitting said common key encrypted with said second key value to said second wireless unit.

8. The method of claim 2 wherein said step of generating said common key value comprises the steps of:
generating said common key as a function of at least one of said first key value and said second key value.

9. The method of claim 1 comprising the step of:
generating said common key as an encryption key.

10. The method of claim 1 comprising the step of:
generating said common key as a session key.

11. The method of claim 1 comprising the step of:
generating a first session key value as a function of a first root key known only at said first wireless unit and a home wireless communications system for said first wireless unit; and
generating said common key as a session encryption key being a function of at least said first session key value.

12. The method of claim 1 comprising the steps of:
mutually producing said common key by a first wireless communications system for said first wireless communications system and a second wireless communications system for said second wireless unit.

13. A method of providing secure communications between a first wireless unit and a second wireless unit, said method comprising the step of:
receiving by a first wireless unit from at least one wireless communications system a common key value for use in secure communications over at least one wireless communications system between said first wireless unit and said second wireless unit having said common key.

14. The method of claim 13 comprising the steps of:
generating a first key value corresponding to said first wireless unit; and
obtaining said common key value by said first wireless unit using said first key value.

15. The method of claim 14 comprising the steps of:
generating a second key value corresponding to said second wireless unit; and
obtaining said common key value by said second wireless unit using said second key value.

16. The method of claim 14 wherein said step of generating comprises the step of:
generating said first key value as a function of a first root key known only at said first wireless unit and a home wireless communications system for said first wireless unit.

17. The method of claim 14 wherein said step of providing comprises the steps of:
decrypting said common key using said first key value.

18. The method of claim 13 comprising the step of:
receiving said common key as an encryption key.

19. The method of claim 13 comprising the step of:
receiving said common key as a session key.

20. The method of claim 13 comprising the steps of:
generating a first session key value as a function of a first root key known only at said first wireless unit and a home wireless communications system for said first wireless unit; and
receiving said common key as a session encryption key being a function of at least said first session key value.
